(19) United States
(12) Patent Application Publication
(10) Pub. No.: US 2025/0371642 A1
(43) Pub. Date: Dec. 4, 2025

(54) SYSTEMS AND METHODS FOR DATA COLLECTION FROM VEHICLES USING SAMPLING AND ANOMALY DETECTION

(71) Applicant: TOYOTA JIDOSHA KABUSHIKI KAISHA, Toyota-shi (JP)

(72) Inventor: Marc CARRÉ, Tokyo (JP)

(73) Assignee: TOYYOTA JIDOSHA KABUSHIKI KAISHA, Toyota-shi (JP)

(21) Appl. No.: 18/680,625

(22) Filed: May 31, 2024

(51) Int. Cl. G06Q 50/40; G06F 11/07; G08G 1/00

(52) U.S. Cl. CPC G06Q 50/40; G06F 11/0739; G08G 1/20

(57) ABSTRACT

Provided are a method, system, and device for optimizing data collection from a plurality of vehicles. The method may include receiving data collected from the plurality of vehicles selected based on one or more sampling criteria; generating a statistical model based on the received data; detecting, based on the statistical model, anomalies in the received data; and updating the one or more sampling criteria based on the anomalies in the received data.

Systems and methods consistent with example embodiments of the present disclosure relate to data collection from vehicles using sampling and anomaly detection.

### BACKGROUND

In the related art, sampling techniques for data collection from vehicles may be used in order to collect data (such as logged data from the Electronic Control Unit (ECU) of the vehicle) from a particular plurality of vehicles (e.g., a fleet of vehicles) which are of interest to the vehicle manufacturer, without having to collect data from every single vehicle. For example, the vehicle manufacturer may opt to collect data from 10% of vehicles which match a particular model. Collecting data may be for the purposes of detecting any errors in software or hardware of vehicles so that they can be actively corrected, or mitigated for the future.

Although sampling may be used in the related art to reduce the total cost of collecting data, the sampling criteria may not necessarily be optimal, since it could include too much irrelevant data, or it could omit the most relevant data. It may not result in finding the most optimal dataset for detecting any errors in the software or hardware without further adjustment of the sampling criteria.

Anomaly detection tools may also miss errors since the logic is often pre-set, and it may not necessarily improve or be adaptable to unknown situations that occur.

Accordingly, there is a need to be able to improve both sampling and anomaly detection techniques in order to optimally collect and analyze data from vehicles.

### SUMMARY

According to one or more example embodiments, a process for optimizing data collection from a plurality of vehicles may be provided. In particular, apparatuses and methods according to example embodiments may include receiving data collected from the plurality of vehicles selected based on one or more sampling criteria (i.e., by a sampling method); generating a statistical model based on the received data (this may be a frequency histogram or some other statistical model); detecting, based on the statistical model, anomalies in the received data; and updating the one or more sampling criteria based on the anomalies in the received data. By using both sampling and anomaly detection techniques in data collection, the overall efficiency of data collection can be improved by mutual reinforcement feedback, since the sampling criteria can be adjusted to be more focused on entries which are more likely to have anomalies, and anomaly detection can be adjusted to more accurately match entries which fall outside the statistical norms as determined by the sampling. Accordingly, the number of data collection operations can be reduced while also improving the accuracy of detecting errors.

According to embodiments, updating the one or more sampling criteria may be based on restricting the sampling criteria to match entries in the statistical model which exceed a standard deviation.

According to embodiments, the method may further include updating logic for anomaly detection in one of the vehicles of the plurality of vehicles based on the statistical model using a machine learning model. Updating logic for anomaly detection may be based on adjusting the range of values which are considered an anomaly based on entries in the statistical model which exceed a standard deviation.

According to embodiments, detecting anomalies in the received data may be further based on receiving a report of anomalous data from one of the vehicles of the plurality of vehicles.

According to embodiments, one or more sampling criteria include at least one of geolocation, vehicle model, vehicle manufacturer, and driver demographic.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 is a diagram of example components of a device according to an example embodiment;

FIG. 2 is a block diagram showing a system architecture for data sampling and analysis according to one or more example embodiments; and

FIG. 3 is a flowchart diagram showing a method for optimizing data collection from a plurality of vehicles according to one or more embodiments.

### DETAILED DESCRIPTION

The following detailed description of example embodiments refers to the accompanying drawings. The disclosure provides illustration and description, but is not intended to be exhaustive or to limit one or more example embodiments to the precise form disclosed. Modifications and variations are possible in light of the disclosure or may be acquired from practice of one or more example embodiments. Further, one or more features or components of one example embodiment may be incorporated into or combined with another example embodiment (or one or more features of another example embodiment). Additionally, in the flowcharts and descriptions of operations provided herein, it is understood that one or more operations may be omitted, one or more operations may be added, one or more operations may be performed simultaneously (at least in part), and the order of one or more operations may be switched.

It will be apparent that example embodiments of systems and/or methods and/or non-transitory computer readable storage mediums described herein may be implemented in different forms of hardware, firmware, or a combination of hardware and software. The actual specialized control hardware or software code used to implement these systems and/or methods is not limiting of one or more example embodiments. Thus, the operation and behavior of the systems and/or methods and/or non-transitory computer readable storage mediums are described herein without reference to specific software code. It is understood that software and hardware may be designed to implement the systems and/or methods based on the descriptions herein.

Even though particular combinations of features are recited in the claims and/or disclosed in the specification, these combinations are not intended to limit the disclosure of possible example embodiments. In fact, many of these features may be combined in ways not specifically recited in the claims and/or disclosed in the specification. Although each dependent claim listed below may directly depend on only one claim, the disclosure of possible example embodiments includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

The term “software part”, as used herein refers to an individual component or unit of software which may implement one or more feature(s). These software parts may be dependent on other software parts. A plurality of software parts which have the same software part type may also be provided. Specifically, a software part type may indicate what the software part is intended for (e.g., SDK, integration, for system testing, etc.). Each of these software part types may have standards (for example, ISO standards) which need to be passed in order for the software part to pass a specific developmental stage (for example, a coverage stage in which the user is still intending to collect and evaluate code coverage metrics only). These standards may be evaluated in terms of metrics. According to some embodiments, each software part may have an identifier including, but not limited to, a version number and a feature name.

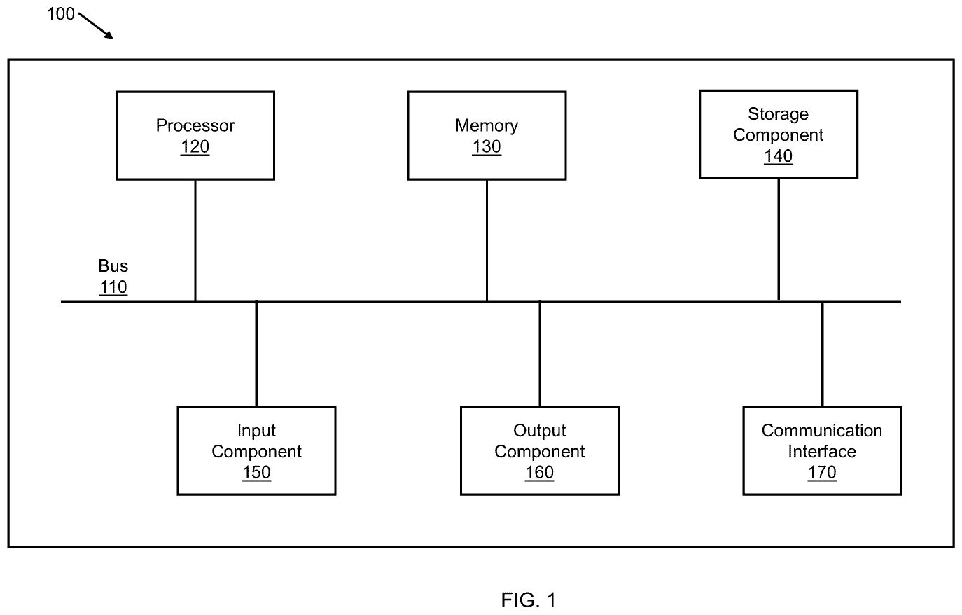

FIG. 1 is a diagram of example components of a device 100. As shown in FIG. 1 device 100 may include a bus 110, a processor 120, a memory 130, a storage component 140, an input component 150, an output component 160, and a communication interface 170.

Bus 110 includes a component that permits communication among the components of device 100. The processor 120 may be implemented in hardware, firmware, or a combination of hardware and software. Processor 120 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In one or more example embodiments, the processor 120 includes one or more processors capable of being programmed to perform a function. The memory 130 includes a random access memory (RAM), a read only memory (ROM), and/or another type of dynamic or static storage device (e.g., a flash memory, a magnetic memory, and/or an optical memory) that stores information and/or instructions for use by the processor 220.

Storage component 140 stores information and/or software related to the operation and use of device 100. For example, the storage component 140 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 150 includes a component that permits device 100 to receive information, such as via user input (e.g., a touch screen display, a keyboard, a keypad, a mouse, a button, a switch, and/or a microphone). Additionally, or alternatively, input component 150 may include a sensor for sensing information (e.g., a global positioning system (GPS) component, an accelerometer, a gyroscope, and/or an actuator). Output component 160 includes a component that provides output information from device 100 (e.g., a display, a speaker, and/or one or more light-emitting diodes (LEDs)).

The communication interface 170 includes a transceiver-like component (e.g., a transceiver and/or a separate receiver and transmitter) that enables device 100 to communicate with other devices, such as via a wired connection, a wireless connection, or a combination of wired and wireless connections. The communication interface 170 may permit the device 100 to receive information from another device and/or provide information to another device. For example, the communication interface 170 may include, but is not limited to, an Ethernet interface, an optical interface, a coaxial interface, an infrared interface, a radio frequency (RF) interface, a universal serial bus (USB) interface, a Wi-Fi interface, a cellular network interface, or the like.

The device 100 may perform one or more example processes described herein. According to one or more example embodiments, the device 100 may perform these processes in response to the processor 120 executing software instructions stored by a non-transitory computer-readable medium, such as the memory 130 and/or the storage component 140. A computer-readable medium is defined herein as a non-transitory memory device. A memory device includes memory space within a single physical storage device or memory space spread across multiple physical storage devices.

Software instructions may be read into the memory 130 and/or the storage component 140 from another computer-readable medium or from another device via the communication interface 170. When executed, software instructions stored in the memory 130 and/or the storage component 140 may cause the processor 120 to perform one or more processes described herein.

Additionally, or alternatively, hardwired circuitry may be used in place of, or in combination with, software instructions to perform one or more processes described herein. Thus, one or more example embodiments described herein are not limited to any specific combination of hardware circuitry and software.

The number and arrangement of components shown in FIG. 1 are provided as an example. In practice, the device 100 may include additional components, fewer components, different components, or differently arranged components than those shown in FIG. 1. Additionally, or alternatively, a set of components (e.g., one or more components) of the device 100 may perform one or more functions described as being performed by another set of components of the device 100.

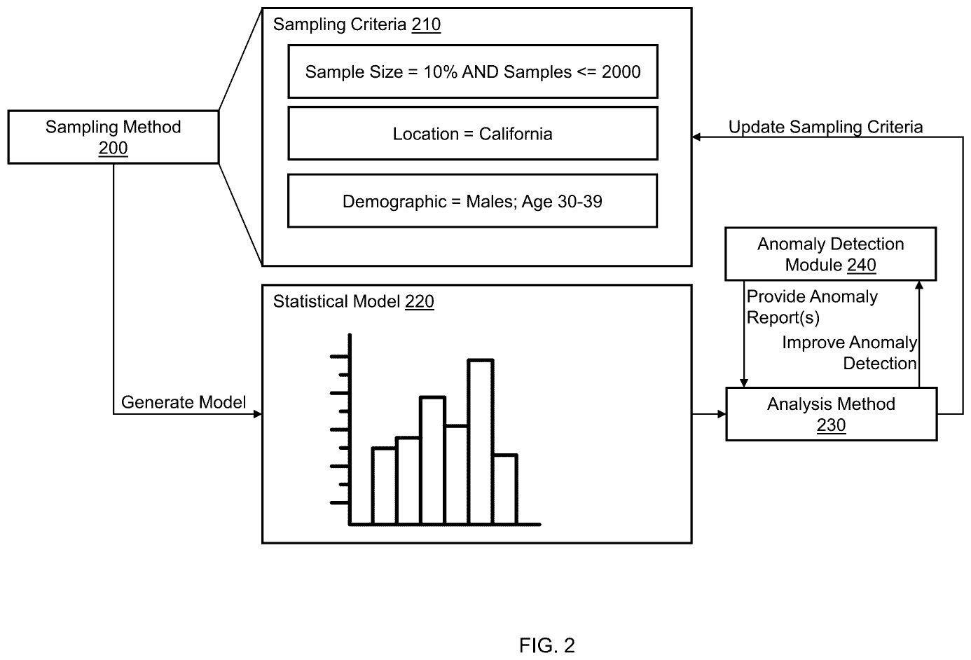

FIG. 2 is a block diagram showing a system architecture for data sampling and analysis according to one or more example embodiments. Sampling method 200, sampling criteria 210, statistical model 220, analysis method 230, and anomaly detection module 240 may be provided.

According to embodiments, sampling method 200 may be applied in order to collect data from a plurality of vehicles. Sampling method 200 may apply sampling criteria 210 in order to restrict the total number of data collected, in particular, sampling criteria 210 may stipulate what kind of data, where to collect it from, or how much data should be collected. Sampling criteria 210 may include, but may not be necessarily be limited to, specifying the vehicle manufacturer, vehicle model, software version(s), geolocation, weather conditions, and/or driver demographic of the vehicles which should be collected from. Sampling criteria 210 may also further limit the specific number of data samples which should be collected. Sampling criteria 210 may also specify the specific data type which should be collected.

In the example system architecture illustrated in FIG. 2, sampling criteria 210 indicates that the user opted to collect 10% of data (for example, accelerometer data) from all vehicles in California registered to males between the age of 30 and 39 as a demographic, including a condition that the total number of samples should not exceed 2000. According to embodiments, the maximum total number of samples may be evaluated based on the assumed probability distribution, confidence level, and margin of error on the samples. According to embodiments, the total number of samples may also be determined based on a previous version of statistical model 220, such that the total number of samples have a statistical likelihood to find an error or anomaly. An anomaly may refer to any behavior which is outside of what is expected from the normal operation of the vehicle. For example, if the brake light in one of the vehicles was determined to be functioning improperly based on cross-referencing accelerometer data and the brake light status using analysis method 230, this result may be flagged as an anomaly. According to embodiments, a machine learning model may be implemented to determine the total number of samples required.

Statistical model 220 may be generated based on the data which is collected from sampling method 200 using sampling criteria 210. The specific structure for statistical model 220 may depend on the specific implementation, but for example, a frequency histogram could be used to visualize where anomalies may occur.

Analysis method 230 may be applied on statistical model 220 to find one or more anomalies. An anomaly may be determined to exist in statistical model 220 based on, for example, based on a certain range of values exceeding a certain threshold (for example, exceeding a standard deviation). For instance, any values exceed a standard deviation of the mean sample values can be flagged as an anomaly. Nevertheless, it should be appreciated that other methods of analysis (such as applying machine learning models) may be implemented by analysis method 230 in order to determine anomalies in statistical model 220. As previously indicated, statistical model 220 may also be used in order to determine the optimal number of samples required for future sampling based on the total percentage of anomalies which were detected. The quality of statistical model 220 itself may also be evaluated by analysis method 230 by evaluating the entropy across all collected samples.

Anomaly detection module 240 (which may be located in the vehicle) may report anomalies to be used by analysis method 230. In particular, anomalies reported by the vehicle may be cross-referenced with statistical model 220 in order to allow analysis method 230 to determine, with additional accuracy, which entries are considered as anomalies in the statistical model. For example, values which exceed a standard deviation of the mean sample values may be compared to the reports from anomaly detection module 240 to see if they match. Anomaly detection module 240 may operate based on a logic rule (for example, simply based on whether a value exceeds a predetermined value), nevertheless, machine learning techniques may also be implemented. For example, supervised machine learning may use training data to help anomaly detection module 240 to improve detection of anomalies. Other anomaly detection tools (such as un-supervised, self-learning) may be used depending on the specific implementation.

After analysis method 230 is finished performing analysis on statistical model 220, the feedback may be used in order to improve future sampling and anomaly detection. In particular, sampling criteria 210 for sampling may be updated in order to restrict/focus the sampling criteria to match entries in statistical model 220 which were determined as anomalous. This may be performed, for example, using a machine learning model. As an example, if the initial sampling performed by sampling method 200 had a sampling criteria 210 for a geolocation criteria of California, but the anomalies were determined by analysis method 230 to be most frequent within a specific vehicle model by the machine learning model (for example, if a machine learning model determines those entries exceeded a standard deviation), future versions of sampling criteria 210 may be adjusted to target the specific vehicle model identified by analysis method 230.

As another example, the initial sampling performed by sampling method 200 may not have any restriction on temperature and sampling criteria 210 may be focused on a specific geolocation (e.g., California). However, analysis method 230 may determine that an anomaly is occurring with an engine fluid meter when the collected temperature data is below 20 degrees C., accordingly, future versions of sampling criteria 210 may be adjusted to search all engine fluid meter data which also has collected temperature data below 20 degrees C., but additionally remove the geolocation restriction (e.g., the scope of future sampling criteria 210 may be shifted rather than simply restricted).

In a similar manner, anomaly detection performed by anomaly detection module 240 may also be improved based on the analysis performed by analysis method 230 on statistical model 220. For example, in the case where anomaly detection in anomaly detection module 240 is implemented by checking where a value falls outside a range of allowable values, analysis method 230 may have determined based on statistical model 220 that the range of allowable values should be expanded, restricted, or shifted. As another example, if anomaly detection in anomaly detection 240 is being implemented by a supervised machine learning model, the training data can be updated based on the data which was collected from sampling method 200 and/or the generated statistical model 220, such that future iterations of anomaly detection module 240 may learn to detect the similar anomaly, or also be able to find anomalies which are unknown (e.g., there is no present logic for detecting such anomalies but they may follow a pattern which is determined by the machine learning model).

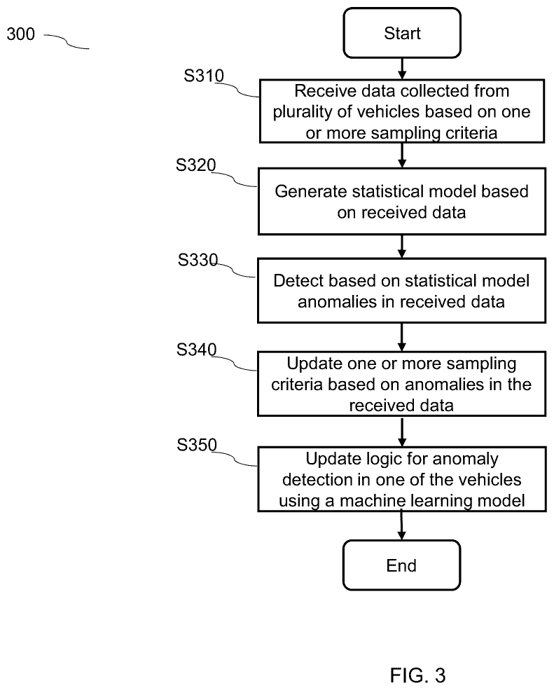

FIG. 3 is a flowchart diagram showing a method 300 for optimizing data collection from a plurality of vehicles according to one or more embodiments.

At operation S310, data which is collected from a plurality of vehicles may be received based on one or more sampling criteria (for example, this may be based on data which is collected based on sampling method 200 using sampling criteria 210 as illustrated in FIG. 2 above). According to embodiments, sampling criteria may include at least one of geolocation, vehicle model, vehicle manufacturer, and driver demographic.

At operation S320, a statistical model (e.g., statistical model 220 illustrated in FIG. 2 above) may be generated based on the received data from operation S310. For example, the statistical model may be represented in the form of a frequency histogram.

At operation S330, anomalies may be detected in the received data based on the statistical model generated in operation S320 (for example, this may be based on using analysis method 230 as illustrated in FIG. 2 above). According to embodiments, detecting anomalies in the received data may be further based on receiving a report of anomalous data from one of the vehicles of the plurality of vehicles (for example, based on anomaly detection module 240 as illustrated in FIG. 2 above).

At operation S340, the one or more sampling criteria may be updated based on anomalies in the received data. According to embodiments, updating the one or more sampling criteria may be performed using a machine learning model. According to embodiments, updating the one or more sampling criteria may also be based on restricting the sampling criteria to match entries in the statistical model which exceed a standard deviation (e.g., exceeding a standard deviation of the mean value of sample values).

At operation S350, logic for anomaly detection in one of the vehicles of the plurality of vehicles may be updated based on the statistical model, for example, using a machine learning model. According to embodiments, updating logic for anomaly detection may be based on adjusting the range of values which are considered an anomaly based on entries in the statistical model which exceed a standard deviation.

By using both sampling and anomaly detection techniques in data collection, the overall efficiency of data collection can be improved by mutual reinforcement feedback, since the sampling criteria can be adjusted to be more focused on entries which are more likely to have anomalies, and anomaly detection can be adjusted to more accurately match entries which fall outside the statistical norms as determined by the sampling. Accordingly, the number of data collection operations can be reduced while also improving the accuracy of detecting errors.

The foregoing disclosure provides illustration and description, but is not intended to be exhaustive or to limit one or more example embodiments to the precise form disclosed. Modifications and variations are possible in light of the disclosure or may be acquired from practice of one or more example embodiments.

One or more example embodiments may relate to a system, a method, and/or a computer readable medium at any possible technical detail level of integration. Further, one or more of the components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In one or more example embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible example embodiments of systems, methods, and computer readable media according to one or more example embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the drawings. In one or more alternative example embodiments, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of one or more example embodiments. Thus, the operation and behavior of the systems and/or methods were described herein without reference to specific software code-it being understood that software and hardware may be designed to implement the systems and/or methods based on the description herein.

What is claimed is:

1. A method for optimizing data collection from a plurality of vehicles, the method comprising:
receiving data collected from the plurality of vehicles selected based on one or more sampling criteria;
generating a statistical model based on the received data;
detecting, based on the statistical model, an anomaly in the received data; and
updating the one or more sampling criteria based on the anomaly in the received data.

2. The method of claim 1, wherein the updating the one or more sampling criteria is performed using a machine learning model.

3. The method of claim 1, wherein the updating the one or more sampling criteria is based on restricting the sampling criteria to match entries in the statistical model which exceed a standard deviation.

4. The method of claim 1, further comprising:
updating logic for anomaly detection in one of the vehicles of the plurality of vehicles based on the statistical model using a machine learning model.

5. The method of claim 4, wherein the updating logic for anomaly detection is based on adjusting a predefined range of values which are considered an anomaly based on entries in the statistical model which exceed a standard deviation.

6. The method of claim 1, wherein the detecting the anomaly in the received data is further based on receiving a report of anomalous data from one of the vehicles of the plurality of vehicles.

7. The method of claim 1, wherein the one or more sampling criteria include at least one of geolocation, vehicle model, vehicle manufacturer, and driver demographic.

8. An apparatus for optimizing data collection from a plurality of vehicles, the apparatus comprising:
at least one memory storing computer-executable instructions; and
at least one processor configured to execute the computer-executable instructions to:
receive data collected from the plurality of vehicles selected based on one or more sampling criteria;
generate a statistical model based on the received data;
detect, based on the statistical model, an anomaly in the received data; and
update the one or more sampling criteria based on the anomaly in the received data.

9. The apparatus of claim 8, wherein updating the one or more sampling criteria is performed using a machine learning model.

10. The apparatus of claim 8, wherein updating the one or more sampling criteria is based on restricting the sampling criteria to match entries in the statistical model which exceed a standard deviation.

11. The apparatus of claim 8, wherein the at least one processor is further configured to execute the computer-executable instructions to:
update logic for anomaly detection in one of the vehicles of the plurality of vehicles based on the statistical model using a machine learning model.

12. The apparatus of claim 11, wherein updating logic for anomaly detection is based on adjusting a predefined range of values which are considered an anomaly based on entries in the statistical model which exceed a standard deviation.

13. The apparatus of claim 8, wherein detecting the anomaly in the received data is further based on receiving a report of anomalous data from one of the vehicles of the plurality of vehicles.

14. The apparatus of claim 8, wherein the one or more sampling criteria include at least one of geolocation, vehicle model, vehicle manufacturer, and driver demographic.

15. A non-transitory computer-readable recording medium having recorded thereon instructions executable by at least one processor to cause the processor to perform a method comprising:
receiving data collected from the plurality of vehicles selected based on one or more sampling criteria;
generating a statistical model based on the received data;
detecting, based on the statistical model, an anomaly in the received data; and
updating the one or more sampling criteria based on the anomaly in the received data.

16. The non-transitory computer-readable recording medium of claim 15, wherein the updating the one or more sampling criteria is performed using a machine learning model.

17. The non-transitory computer-readable recording medium of claim 15, wherein the updating the one or more sampling criteria is based on restricting the sampling criteria to match entries in the statistical model which exceed a standard deviation.

18. The non-transitory computer-readable recording medium of claim 15, wherein the method further comprises:
updating logic for anomaly detection in one of the vehicles of the plurality of vehicles based on the statistical model using a machine learning model.

19. The non-transitory computer-readable recording medium of claim 18, wherein the updating logic for anomaly detection is based on adjusting a predefined range of values which are considered an anomaly based on entries in the statistical model which exceed a standard deviation.

20. The non-transitory computer-readable recording medium of claim 15, wherein the detecting the anomaly in the received data is further based on receiving a report of anomalous data from one of the vehicles of the plurality of vehicles.
